(19) United States
(12) Patent Application Publication
(10) Pub. No.: US 2019/0143339 A1
(43) Pub. Date: May 16, 2019

(54) CHARGER, ELECTRIC DUST COLLECTOR, VENTILATOR, AND AIR CLEANER

(71) Applicant: Panasonic Intellectual Property Management Co., Ltd., Osaka (JP)

(72) Inventor: Satohiko HOSOMI, Osaka (JP)

(73) Assignee: Panasonic Intellectual Property Management Co., Ltd., Osaka (JP)

(21) Appl. No.: 16/302,874

(22) PCT Filed: Feb. 17, 2017
(86) PCT No.: PCT/JP2017/005893

§ 371 Date: Nov. 19, 2018

(30) Foreign Application Priority Data
Jun. 6, 2016 (JP) 2016-113007

(51) Int. Cl. B03C 3/41; B03C 3/68; F24F 7/00; H01T 19/04

(52) U.S. Cl. CPC B03C 3/41; B03C 3/68; F24F 3/1603; H01T 19/04; F24F 7/00

(57) ABSTRACT

A charger includes: a first opposed electrode and a second opposed electrode disposed at mutually opposed positions; a discharge electrode between the first opposed electrode and the second opposed electrode; and a power supply unit that applies a voltage to at least one of the first opposed electrode, the second opposed electrode, and the discharge electrode. A first period in which a first charging region is formed between the first opposed electrode and the discharge electrode and a first non-charging region is formed between the second opposed electrode and the discharge electrode, and a second period in which a second non-charging region is formed between the first opposed electrode and the discharge electrode and a second charging region is formed between the second opposed electrode and the discharge electrode are repeated periodically. In the first charging region and the second charging region, particles are charged to the same polarity.

### TECHNICAL FIELD

The present disclosure relates to a charger which charges particles contained in gas, an electric dust collector including the charger, and apparatuses including the electric dust collector such as a ventilator and an air cleaner.

### BACKGROUND ART

Conventionally, an electric dust collector which removes particles (substances) floating in gas such as air using electrostatic force is known.

Such an electric dust collector mainly includes a charging unit (charger) which charges particles and a collecting unit which collects the particles charged (electrified) by the charging unit. The charging unit includes a pair of opposed electrodes disposed opposite each other and a discharge electrode disposed between the pair of opposed electrodes. In the charging unit, a corona discharge is generated by applying a direct-current high voltage between the discharge electrode and each of the opposed electrodes, and thus the particles are charged positive (+), for example.

However, in such a conventional charging unit as described above, an electrostatic field is formed by the direct-current high voltage in the regions between the discharge electrode and each of the opposed electrodes, and thus charged particles are subjected to electrostatic force toward the opposed electrode while passing through the charging unit, and adhere to the opposed electrode. The particles which adhere to the opposed electrode as described above accumulate over time, and the distance between the discharge electrode and the opposed electrode may become short due to the accumulated particles (accumulated layers). Furthermore, when the particles are a high-resistance substance, a back corona may occur in the accumulated layers of particles. Furthermore, the particles which have adhered to the opposed electrode once may scatter again. Due to the phenomena described above caused by the accumulation of the particles on the opposed electrode, a spark (spark discharge) which is an abnormal discharge may be induced. When a spark occurs, a high current flows through the discharge electrode, and thus the discharge electrode itself produces heat, resulting in melting or disconnecting, which may cause breakdown of the charger.

Therefore, conventionally, a charging unit which applies an alternating-current voltage between a discharge electrode and an opposed electrode to generate an alternating-current corona discharge (see Patent Literature 1). In this case, since an alternating-current voltage is applied, charged particles pass through the charging unit while meandering, and thus adhesion of the charged particles to the opposed electrode can be reduced.

### CITATION LIST

### Patent Literature

PTL 1: Japanese Unexamined Patent Application Publication No. H11-216391

### SUMMARY OF THE INVENTION

### Technical Problems

However, in the charging unit according to Patent Literature 1, since an alternating-current corona discharge is generated, both positive ions and negative ions are generated. Accordingly, in the charging unit, positively charged particles and negatively charged particles are generated. Because of this, there is a problem of deterioration of the charging efficiency caused by charge neutralization between the positively charged particles and the negatively charged particles, which occurs during travel of the charged particles to reach the dust collection unit.

Of course, the frequency of the alternating-current voltage may be lowered so as to reduce the charge neutralization between the particles, but in this case, there is a problem of increasing the risk of adhesion of the particles to the electrode because amplitude of the meandering movement of the particles becomes large.

The present disclosure is conceived to solve the above-described problems, and has as an object to provide a charger and the like which can reduce deterioration of charging efficiency and adhesion of particles to the electrodes.

### Solutions to Problems

In order to solve the above problems, a charger according to an aspect of the present disclosure is a charger that charges particles in gas includes: a first opposed electrode and a second opposed electrode disposed at mutually opposed positions; a discharge electrode between the first opposed electrode and the second opposed electrode; and a power supply unit configured to apply an alternating-current voltage to at least one of the first opposed electrode, the second opposed electrode, and the discharge electrode. A first period in which a first charging region is formed between the first opposed electrode and the discharge electrode and a first non-charging region is formed between the second opposed electrode and the discharge electrode, and a second period in which a second non-charging region is formed between the first opposed electrode and the discharge electrode and a second charging region is formed between the second opposed electrode and the discharge electrode are repeated periodically by application of the alternating-current voltage. In the first charging region and the second charging region, the particles are charged to a same polarity, and charging efficiency of the particles in the first non-charging region and the second non-charging region is lower than charging efficiency of the particles in the first charging region and the second charging region.

Furthermore, in order to solve the above problems, a charger according to an aspect of the present disclosure includes: a first opposed electrode and a second opposed electrode disposed at mutually opposed positions; a discharge electrode between the first opposed electrode and the second opposed electrode; and a power supply unit configured to apply voltages to the first opposed electrode, the second opposed electrode, and the discharge electrode. When a potential applied to the first opposed electrode is denoted by V1, a potential applied to the second opposed electrode is denoted by V2, and a potential applied to the discharge electrode is denoted by V3, the power supply unit is configured to apply voltages to the discharge electrode, the first opposed electrode, and the second opposed electrode to periodically repeat a first period satisfying relationships V3>V1 and V3≤V2 and a second period satisfying relationships V3>V2 and V3≤V1, or to periodically repeat a first period satisfying relationships V3<V1 and V3≥V2 and a second period satisfying relationships V3<V2 and V3≥V1.

Furthermore, in order to solve the above problems, an electric dust collector according to an aspect of the present disclosure includes the charger described above.

Furthermore, in order to solve the above problems, a ventilator according to an aspect of the present disclosure includes the electric dust collector described above.

Furthermore, in order to solve the above problems, an air cleaner according to an aspect of the present disclosure includes the electric dust collector described above.

### Advantageous Effect of Invention

According to the present disclosure, a charger and the like which can reduce deterioration of charging efficiency and adhesion of particles to the electrodes can be provided.

### BRIEF DESCRIPTION OF DRAWINGS

FIG. 1 is a block diagram outlining an overall configuration of an electric dust collector according to an embodiment.

FIG. 2 is a perspective view outlining the overall configuration of the electric dust collector according to the embodiment.

FIG. 3 is a circuit diagram outlining a circuit configuration of a charger according to the embodiment.

FIG. 4 is a graph illustrating waveforms of potentials applied to each electrode of the charger according to the embodiment.

FIG. 5 is a schematic diagram illustrating operation of the charger according to the embodiment in the first period.

FIG. 6 is a schematic diagram illustrating operation of the charger according to the embodiment in the second period.

FIG. 7 is a circuit diagram outlining a circuit configuration of a charger according to a variation.

FIG. 8 is a diagram illustrating an external appearance of a ventilator according to the variation.

FIG. 9 is a diagram illustrating an external appearance of an air cleaner according to the variation.

FIG. 10 is a diagram illustrating an external appearance of an air conditioner according to the variation.

### DESCRIPTION OF EXEMPLARY EMBODIMENTS

Embodiments of the present disclosure will be described below with reference to the drawings. The embodiments described below each illustrate a particular example of the present disclosure. Thus, the numerical values, shapes, materials, elements, the arrangement and connection of the elements, etc. indicated in the following embodiments are mere examples, and are not intended to limit the present disclosure. Therefore, among the elements in the following embodiments, elements not recited in any of the independent claims defining the most generic concept of the present disclosure are described as optional elements.

Furthermore, the drawings are schematic and do not necessarily provide precise depictions. Throughout the drawings, like elements share like reference signs and redundant description is omitted or simplified.

### EMBODIMENT

[1. Overall Configuration]

First, an overall configuration of a charger and an electric dust collector including the charger according to an embodiment will be described with reference to the drawings.

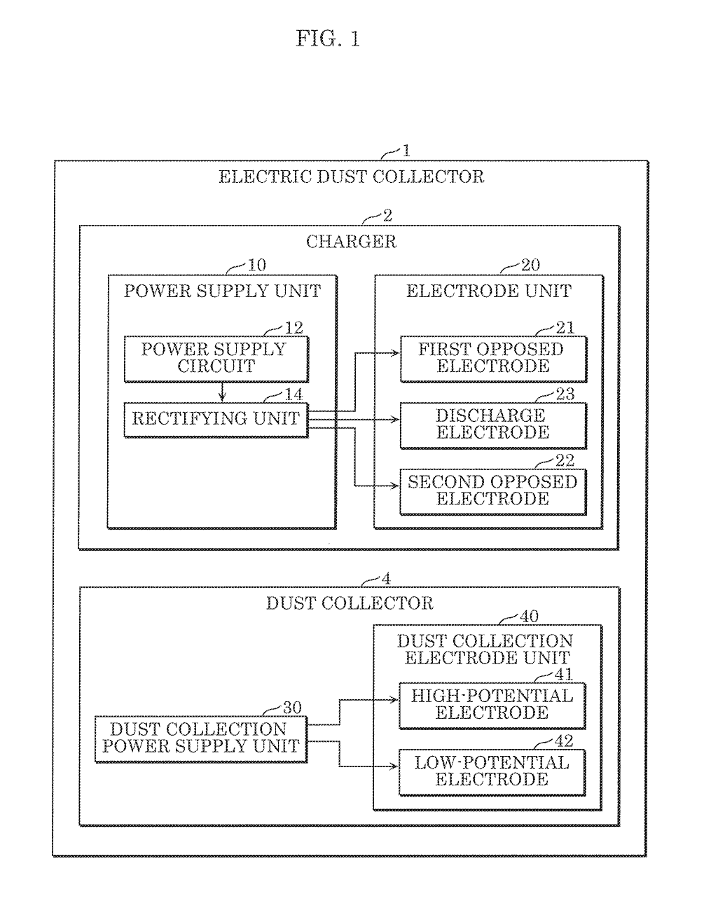

FIG. 1 is a block diagram outlining the overall configuration of electric dust collector 1 according to this embodiment. FIG. 2 is a perspective view outlining the overall configuration of electric dust collector 1 according to this embodiment.

Electric dust collector 1 according to this embodiment is an apparatus which collects particles in gas. Electric dust collector 1 is, for example, installed in an air supply duct, or the like of a ventilation system, as a part of a ventilator, removes at least part of particles 90 in the gas flowing into electric dust collector 1, and discharges the cleaned gas. In this embodiment, air is used as an example of the gas.

As illustrated in FIG. 1, electric dust collector 1 functionally includes charger 2 and dust collector 4. It should be noted that, in FIG. 2, the direction in which the gas flows is the Z-axis direction. The gas flows in the positive direction of the Z-axis in this embodiment (see arrows in FIG. 2). Furthermore, the two directions that are perpendicular to the Z-axis and orthogonal to each other are the X-axis direction and the Y-axis direction. Furthermore, the alignment direction of first opposed electrodes 21 and second opposed electrode 22 illustrated in FIG. 2 is the X-axis direction. The gas is introduced into electric dust collector 1 by a fan, or the like disposed outside of electric dust collector 1. It should be noted that the fan may be disposed inside of electric dust collector 1.

Charger 2 and dust collector 4 will be described in detail below.

[1-1. Charger]

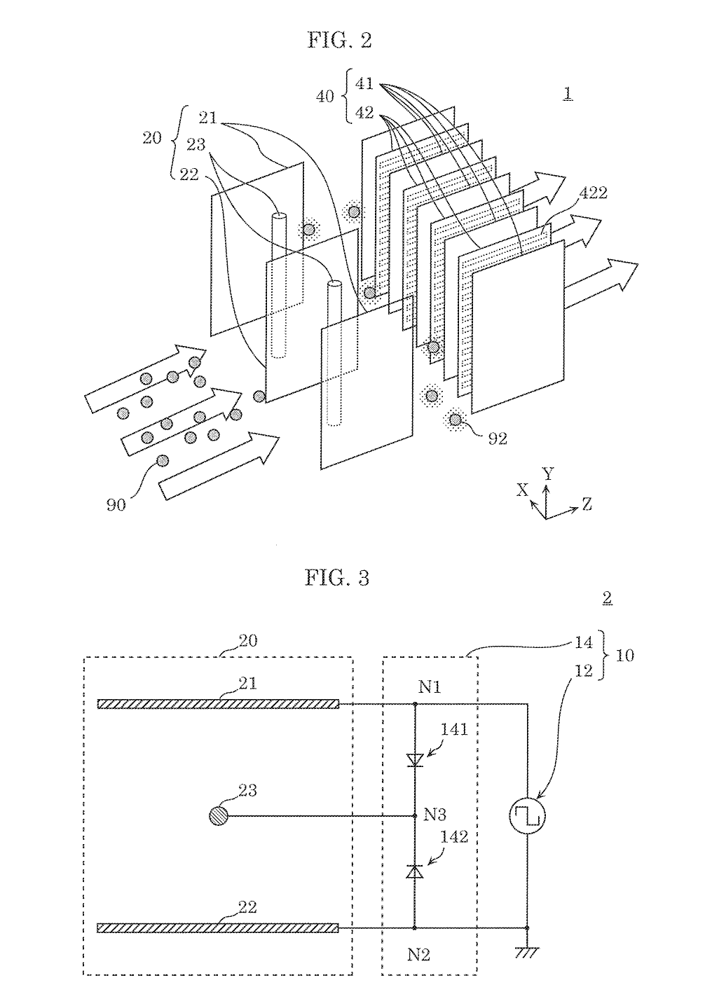

Charger 2 is a particle charging unit which charges (electrifies) particles 90 in the gas flowing into electric dust collector 1. Charger 2 will be described with reference to FIG. 3 in addition to FIG. 1 and FIG. 2.

FIG. 3 is a circuit diagram outlining a circuit configuration of charger 2 according to this embodiment.

As illustrated in FIG. 1 and FIG. 3, charger 2 includes power supply unit 10 and electrode unit 20.

Electrode unit 20 is an electrode which generates a corona discharge for charging particles 90 in the gas. Particles 90 flowing into electrode unit 20 in the arrow direction illustrated in FIG. 2 are charged in electrode unit 20, and flow out of electrode unit 20 as charged particles 92. Electrode unit 20 includes first opposed electrode 21 and second opposed electrode 22 which are disposed opposite each other, and discharge electrode 23 disposed between first opposed electrode 21 and second opposed electrode 22. It should be noted that there may be a plurality of pairs of first opposed electrode 21 and second opposed electrode 22. In other words, there only has to be at least a single pair of first opposed electrode 21 and second opposed electrode 22. Furthermore, as illustrated in FIG. 2, second opposed electrode 22 may be disposed to be opposite each of two first opposed electrodes 21.

As illustrated in FIG. 2 and FIG. 3, first opposed electrode 21 and second opposed electrode 22 have a flat-plate shape. The length of first opposed electrode 21 and second opposed electrode 22 (length in the cross direction in FIG. 3, in other words, length in the direction in which the gas flows) is approximately 30 mm, for example. The material of first opposed electrode 21 and second opposed electrode 22 only has to be a conductive material and is not particularly limited. First opposed electrode 21 and second opposed electrode 22 are formed from stainless steel, for example.

Discharge electrode 23 is an electrode that causes a discharge in the vicinity, and has such a shape that the electric field intensity in the vicinity of discharge electrode 23 becomes larger than in the vicinities of first opposed electrode 21 and second opposed electrode 22. In this embodiment, discharge electrode 23 has a thin linear shape, as illustrated in FIG. 2 and FIG. 3. The diameter of discharge electrode 23 is approximately 0.25 mm, for example. It should be noted that the shape of discharge electrode 23 is not limited to a thin linear shape, and may be plate-shaped with a sharp-angle portion, for example. The material of discharge electrode 23 only has to be a conductive material and is not particularly limited. Discharge electrode 23 is formed from stainless steel, tungsten, or the like, for example. Furthermore, the distance between discharge electrode 23 and each of first opposed electrode 21 and second opposed electrode 22 is approximately 15 mm, for example.

Power supply unit 10 is a device which applies an alternating-current voltage to at least one of first opposed electrode 21, second opposed electrode 22, and discharge electrode 23 of electrode unit 20. In this embodiment, power supply unit 10 includes power supply circuit 12 and rectifying unit 14.

Power supply circuit 12 is a circuit which outputs an alternating-current voltage. In this embodiment, power supply circuit 12 outputs a voltage having a rectangular waveform as the alternating-current voltage. It should be noted that the waveform of the alternating-current voltage is not limited to a rectangular shape. The waveform of the alternating-current voltage may be, for example, trapezoidal wave-shaped, triangular, sinusoidal wave-shaped, pulsed wave-shaped, or the like. The magnitude of the alternating-current voltage is approximately 11 kV, for example, and the frequency is approximately 100 Hz at least and 10 kHz at most, for example. Power is supplied to power supply circuit 12 from a system power supply (not illustrated) such as a commercial alternating-current power supply, for example. As illustrated in FIG. 3, in this embodiment, one output terminal of power supply circuit 12 is connected to node N1 to which first opposed electrode 21 is connected. On the other hand, the other output terminal of power supply circuit 12 is connected to node N2 to which second opposed electrode 22 is connected. It should be noted that, in this embodiment, node N2 is grounded, as illustrated in FIG. 3.

Rectifying unit 14 is a circuit which rectifies the alternating-current voltage output from power supply circuit 12, and applies the rectified voltage to discharge electrode 23. Because of rectifying unit 14, the potential of discharge electrode 23 becomes the same as the potential of either first opposite electrode 21 or second opposite electrode 22 in a half cycle of the alternating-current voltage output from power supply unit 12. In this embodiment, rectifying unit 14 applies, to discharge electrode 23, the higher potential between the potentials applied to first opposite electrode 21 and second opposite electrode 22.

Specifically, as illustrated in FIG. 3, rectifying unit 14 includes first rectifying element 141 connected between discharge electrode 23 and first opposed electrode 21, and second rectifying element 142 connected between discharge electrode 23 and second opposed electrode 22. As first rectifying element 141 and second rectifying element 142, a diode is used, for example. In this embodiment, the anode of first rectifying element 141 is connected to node N1 (in other words, first opposed electrode 21) and the cathode of first rectifying element 141 is connected to node N3 (in other words, discharge electrode 23), respectively. On the other hand, the anode of first rectifying element 142 is connected to node N2 (in other words, second opposed electrode 22) and the cathode of second rectifying element 142 is connected to node N3 (in other words, discharge electrode 23), respectively.

[1-2. Dust Collector]

Dust collector 4 is an apparatus which separates charged particles 92 in the gas from the gas, and collects charged particles 92. The gas containing charged particles 92 charged by charger 2 is introduced into dust collector 4. The configuration of dust collector 4 is not particularly limited as long as dust collector 4 is capable of separating charged particles 92 from the gas. In this embodiment, dust collector 4 includes dust collection power supply unit 30 and dust collection electrode unit 40, as illustrated in FIG. 1.

Dust collection power supply unit 30 is a power supply which applies a voltage to each electrode of dust collection electrode unit 40.

Dust collection electrode unit 40 is an electrode unit which forms an electric field for separating charged particles 92 from the gas. In this embodiment, dust collection electrode unit 40 includes high-potential electrodes 41 and low-potential electrodes 42.

High-potential electrode 41 is an electrode to which a voltage is applied from dust collection power supply unit 30 so as to have a higher potential than low-potential electrode 42. The configuration of high-potential electrode 41 is not particularly limited. High-potential electrode 41 may be a film-shaped electrode pattern formed on a substrate formed from an insulating material, or a sheet-shaped or a wire-shaped electrode embedded in the insulating material, for example. Furthermore, an insulating film may be further provided on the electrode pattern described above. As the substrate formed from an insulating material, a substrate including ceramics, glass epoxy, or the like as the main component can be used, for example. As the electrode pattern, a conductive film including copper as the main component can be used, for example. As the insulating film, an insulating material such as silicon oxide can be used, for example.

Low-potential electrode 42 is an electrode to which a voltage is applied from dust collection power supply unit 30 so as to have a lower potential than high-potential electrode 41. The configuration of low-potential electrode 42 is not particularly limited. Low-potential electrode 42 may be a film-shape electrode pattern formed on a substrate formed from an insulating material, or a sheet-shape or a wire-shape electrode embedded in the insulating material, for example. Furthermore, an insulating film may be further provided on the electrode pattern described above. Furthermore, when particles 90 are charged mainly positive (+) as in electric dust collector 1 according to this embodiment, charged particles 92 adhere to low-potential electrode 42. In view of this, a configuration in which charged particles 92 that have adhered to low-potential electrode 42 can be removed by a traveling-wave electric field may be adopted. Specifically, as low-potential electrode 42, for example, as illustrated in FIG. 2, a plurality of linear electrodes 422 are used. In addition, the traveling-wave electric field may be formed by maintaining each of linear electrodes 422 to have the same potential when causing charged particles 92 to adhere to low-potential electrode 42, and changing the voltage applied to each of linear electrodes 422 when removing charged particles 92 that have adhered. Accordingly, the maintenance work for dust collector 4 can be reduced.

The dimensions of high-potential electrode 41 and low-potential electrode 42 are designed, as appropriate, according to the flow rate of the gas, etc. The distance between high-potential electrode 41 and low-potential electrode 42 is designed, as appropriate, according to the potentials, etc. to be applied to high-potential electrode 41 and low-potential electrode 42. The interval is approximately 4 mm, for example. When collecting charged particles 92, potentials of approximately 4 kV and 0 V are applied to high-potential electrode 41 and low-potential electrode 42, respectively, for example. Furthermore, when removing charged particles 92 which have adhered to low-potential electrode 42, a changing potential for forming a traveling-wave electric field is applied to each of linear electrodes 422 of low-potential electrode 42. The width (dimension in the Y-axis direction in FIG. 2) of linear electrode 422 is approximately 0.2 mm, and the interval between adjacent linear electrodes 422 is approximately 0.4 mm. In this case, a changing potential having a maximum value of approximately 800 V, for example, is applied to each linear electrode 422.

[2. Operation]

Next, operation of charger 2 of electric dust collector 1 according to this embodiment will be described with reference to the drawings.

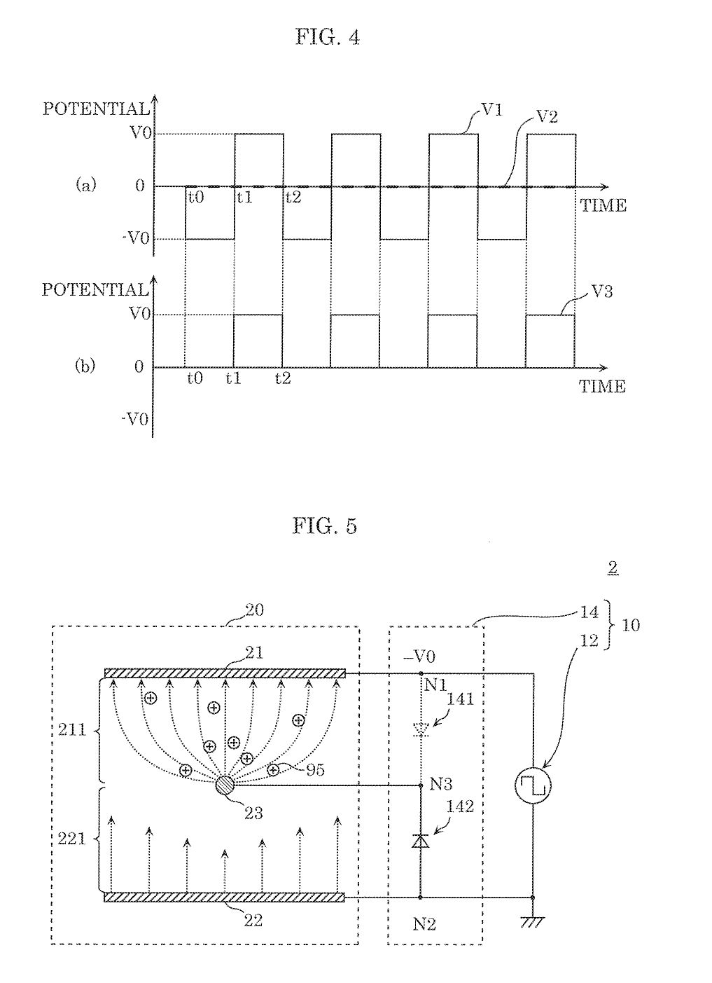

FIG. 4 is a graph illustrating waveforms of potentials to be applied to each electrode of charger 2 according to this embodiment. In graph (a) of FIG. 4, the waveforms of potentials to be applied to first opposed electrode 21 and second opposed electrode 22 are illustrated. The waveforms in the solid line and the broken line in graph (a) show the waveform of potential V1 to be applied to first opposed electrode 21 and the waveform of potential V2 to be applied to second opposed electrode 22, respectively. In graph (b) of FIG. 4, the waveform of potential V3 to be applied to discharge electrode 23 is illustrated.

As illustrated in graph (a) of FIG. 4, a potential corresponding to an alternating-current voltage output from power supply circuit 12 is applied to first opposed electrode 21. On the other hand, since second opposed electrode 22 is grounded, the potential is maintained at 0 V. It should be noted that the waveform of the alternating-current voltage is not limited to the example illustrated in graph (a) of FIG. 4. For example, there may be a period in which the output from power supply circuit 12 is 0 V (idle period). By providing an idle period, the total current amount of a corona discharge can be reduced, and thus power consumption of charger 2 can be reduced. Furthermore, by providing an idle period, the amount of ozone generated by a corona discharge can also be reduced.

Furthermore, as stated above, a voltage obtained through rectification of the alternating-current voltage output from power supply circuit 12 by rectifying unit 14 is applied to discharge electrode 23. In other words, a potential equal to the higher potential between the potentials applied to first opposed electrode 21 and second opposed electrode 22, is applied to discharge electrode 23. Therefore, as illustrated in graph (b) of FIG. 4, since a potential of −V0 [V] is applied to first opposed electrode 21 and a potential of 0 [V] is applied to second opposed electrode 22 in the period from time t0 to time t1, a potential of 0 [V] is applied to discharge electrode 23.

As described above, in the period from time t0 to time t1, a relatively strong electric field (in which a corona discharge is generated) is formed in the vicinity of discharge electrode 23 on the first opposed electrode 21 side, and a relatively weak electric field (to the extent that a corona discharge is not generated) is formed in the vicinity of discharge electrode 23 on the second opposed electrode 22 side. The operation in the first period described above will be described with reference to FIG. 5.

FIG. 5 is a schematic view of the operation of charger 2 according to this embodiment in the first period.

As can be understood from the lines of electric force illustrated by the dotted arrows in FIG. 5, a relatively strong electric field is formed in the vicinity of discharge electrode 23 on the first opposed electrode 21 side. Accordingly, a corona discharge occurs between first opposed electrode 21 and discharge electrode 23. With the occurrence of the corona discharge, positive ions and negative ions (or electrons) are generated between first opposed electrode 21 and discharge electrode 23. Here, the corona discharge occurs mainly in the region having a high electric field intensity, in other words, in the region around discharge electrode 23. The negative ions (or electrons) generated in the region swiftly move the short distance to discharge electrode 23. On the other hand, positive ions 95 generated in the region move from the vicinity of discharge electrode 23 to first opposed electrode 21, as illustrated in FIG. 5. Accordingly, there are substantially only positive ions 95 in most of the region between first opposed electrode 21 and discharge electrode 23 in the first period. Accordingly, particles introduced into the region are mainly charged positive. Hereinafter, the region formed between first opposed electrode 21 and discharge electrode 23 in the first period as described above will be called first charging region 211. It should be noted that it is also possible to cause many negative ions to be present in first charging region 211. For example, by reversing the respective orientations of first rectifying element 141 and second rectifying element 142 and thus making the potential of discharge electrode 23 lower than first opposed electrode 21, it is possible to cause many negative ions to be present in first charging region 211.

Furthermore, since the potentials of second opposed electrode 22 and discharge electrode 23 are both maintained at 0 [V] in the first period, the electric field intensity in the vicinity of discharge electrode 23 on the second opposed electrode 22 side is lower than first charging region 211. Because of this, the charging efficiency of the particles in the region is lower than first charging region 211. In this embodiment, the particles in the region are substantially not charged. Hereinafter, the region will be called first non-charging region 221. In first non-charging region 221, an electric field is formed between second opposed electrode 22 whose potential is maintained at 0 [V] and first opposed electrode 21 whose potential is maintained at −V0 [V]. In the spatial average electric field in first non-charging region 221, the orientation of the component of the alignment direction of first opposed electrode 21 and second opposed electrode 22 (the up-down direction in FIG. 5) is, as illustrated in FIG. 5, an orientation from second opposed electrode 22 toward first opposed electrode 21 (the upward orientation in FIG. 5). It should be noted that the spatial average electric field is defined by the averages of the intensity and the orientation of the electric field in a predetermined space. This orientation coincides with the orientation of the component of the aforementioned alignment direction in the spatial average electric field, in first charging region 211. In other words, in the first period, in each of first charging region 211 and first non-charging region 221, when averaged, an electric field oriented from second opposed electrode 22 toward first opposed electrode 21 (the upward orientation in FIG. 5) is formed. Accordingly, in the first period, the positively-charged charged particles 92 are subjected to force in the orientation of the electric field (the upward orientation in FIG. 5).

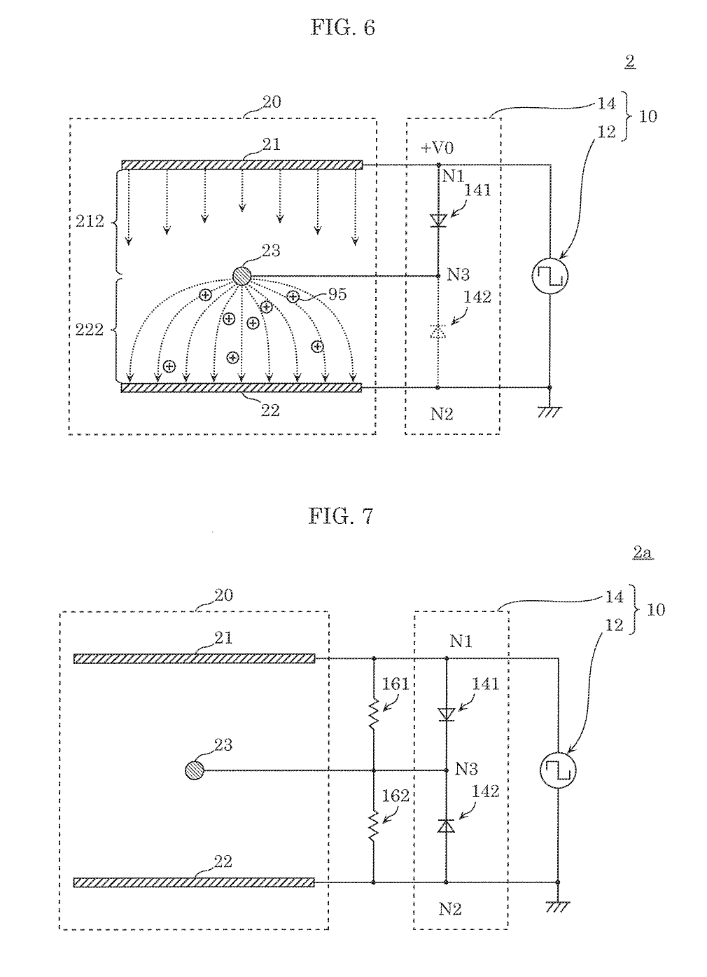

On the other hand, in the period from time t1 to time t2 illustrated in FIG. 4, a relatively weak electric field (to the extent that a corona discharge is not generated) is formed in the vicinity of discharge electrode 23 on the first opposed electrode 21 side, and a relatively strong electric field (in which a corona discharge is generated) is formed in the vicinity of discharge electrode 23 on the second opposed electrode 22 side. The operation in the second period described above will be described with reference to FIG. 6.

FIG. 6 is a schematic view of the operation of charger 2 according to this embodiment in the second period.

As can be understood from the lines of electric force illustrated by the dotted arrows in FIG. 6, in the second period, a relatively strong electric field is formed in the vicinity of discharge electrode 23 on the second opposed electrode 22 side. Accordingly, a corona discharge occurs between second opposed electrode 22 and discharge electrode 23. Subsequently, as in first charging region 211 described above, there are substantially only positive ions 95 in most of the region between second opposed electrode 22 and discharge electrode 23 in the second period. Accordingly, particles 90 introduced into the region are mainly charged positive. Hereinafter, the region formed between second opposed electrode 22 and discharge electrode 23 in the second period as described above will be called second charging region 222.

Furthermore, since the potentials of first opposed electrode 21 and discharge electrode 23 are both maintained at +V0 [V] in the second period, the electric field intensity in the vicinity of discharge electrode 23 on the first opposed electrode 21 side is lower than second charging region 222. Because of this, the charging efficiency of the particles in the region is lower than second charging region 222. In this embodiment, the particles in the region are substantially not charged. Hereinafter, the region will be called second non-charging region 212. In second non-charging region 212, an electric field is formed between first opposed electrode 21 whose potential is maintained at +V0 [V] and second opposed electrode 22 whose potential is maintained at 0 [V]. In the spatial average electric field in second non-charging region 212, the orientation of the component of the alignment direction of first opposed electrode 21 and second opposed electrode 22 (the up-down direction in FIG. 6) is, as illustrated in FIG. 6, an orientation from first opposed electrode 21 toward second opposed electrode 22 (the downward orientation in FIG. 6). This orientation coincides with the orientation of the component of the aforementioned alignment direction in the spatial average electric field, in second charging region 222. In other words, in the second period, in each of first charging region 211 and first non-charging region 221, when averaged, an electric field oriented from first opposed electrode 21 toward second opposed electrode 22 (the downward orientation in FIG. 6) is formed. Accordingly, in the second period, the positively-charged charged particles 92 are subjected to force in the orientation of the electric field (the downward orientation in FIG. 6).

As described above, in charger 2, the first period in which first charging region 211 is formed between discharge electrode 23 and first opposed electrode 21 and first non-charging region 221 is formed between second opposed electrode 22 and discharge electrode 23, and the second period in which second non-charging region 212 is formed between first opposed electrode 21 and discharge electrode 23 and second charging region 222 is formed between second opposed electrode 22 and discharge electrode 23 are repeated periodically by the application of an alternating-current voltage to electrode unit 20 by power supply unit 10. Here, in first charging region 211 and second charging region 222, particles 90 are charged to the same polarity. In this embodiment, particles 90 are charged positive. The charging efficiency of particles 90 in first non-charging region 221 and second non-charging region 212 is lower than the charging efficiency of particles 90 in first charging region 211 and second charging region 222.

Furthermore, in other words, in charger 2 according to this embodiment, as illustrated in FIG. 4, when the potential applied to first opposed electrode 21 is denoted by V1, the potential applied to second opposed electrode 22 by V2, and the potential applied to discharge electrode 23 by V3, power supply unit 10 applies potentials to first opposed electrode 21, second opposed electrode 22, and discharge electrode 23 to periodically repeat the first period satisfying the relationships V3>V1 and V3=V2 and the second period satisfying the relationships V3>V2 and V3=V1.

Accordingly, in charger 2, particles 90 can be charged in either first charging region 211 or second charging region 222. Furthermore, in charger 2 according to this embodiment, particles 90 which pass through first charging region 211 and second charging region 222 are charged to the same polarity. In other words, particles 90 can be charged with unipolar ions (positive ions in this embodiment). Therefore, it is possible to prevent mixing of particles 90 charged with positive ions and particles 90 charged with negative ions and thereby prevent mutual charge neutralization between the positively charged particles and the negatively charged particles. As a result, deterioration of the charging efficiency can be reduced.

Furthermore, in this embodiment, in the first period, the same potential as discharge electrode 23 is applied to second opposed electrode 22. Because of this, the local electric field in the vicinity of discharge electrode 23 is mitigated, for example, compared with the case where the same potential as first opposed electrode 21 is applied to second opposed electrode 22. Accordingly, an applied voltage required to initiate a corona discharge becomes high. Accordingly, the spatial electric field intensity in first charging region 211 can be improved. Here, quantity of saturated charge q of particles 90 which pass through charger 2 is expressed using equation (1) below.

$$\begin{matrix}[ Math . 1 ] & \\ q = 4 π {ɛ}_{0} \frac{{3}_{{ɛ}_{s}}}{{ɛ}_{s} + 2} {a}^{2} E & ( 1 )\end{matrix}$$

It should be noted that, in equation (1) above, ε₀ denotes the permittivity in a vacuum, εₛ denotes the relative permittivity of the particles, a denotes the radius of the particles, and E denotes charged electric field intensity (spatial electric field intensity), respectively. As shown in equation (1) above, quantity of saturated charge q is proportion to charge electric field intensity E. Therefore, in this embodiment, quantity of saturated charge q of particles 90 can be increased. In the second period too, quantity of saturated charge q can be increased, as in the first period.

Furthermore, in this embodiment, the orientation of the electric field formed between first opposed electrode 21 and second opposed electrode 22 is reversed between the first period and the second period. Therefore, charged particles 92 pass through between first opposed electrode 21 and second opposed electrode 22 while meandering. This can also prevent charged particles 92 from adhering to first opposed electrode 21 and second opposed electrode 22.

Furthermore, as stated above, in the first period, the orientation of the component of the alignment direction of first opposed electrode 21 and second opposed electrode 22, in the spatial average electric field in first charging region 211, coincides with the orientation of the component of the aforementioned alignment direction in the spatial average electric field, in first non-charging region 221. Furthermore, in the second period, the orientation of the component of the aforementioned alignment direction, in the spatial average electric field in second charging region 222, coincides with the orientation of the component of the aforementioned alignment direction in the spatial average electric field, in second non-charging region 212. Therefore, in this embodiment, in the space between first opposed electrode 21 and second opposed electrode 22, the orientation of the spatial average electric field is an orientation from second opposed electrode 22 toward first opposed electrode 21 in the first period, and is an orientation from first opposed electrode 21 toward second opposed electrode 22 in the second period. As described above, in the space as a whole, the orientation of the electric field is reversed between the first period and the second period, and thus charged particles 92 pass through the space while meandering, regardless of the location in the space. This can prevent charged particles 92 from adhering to first opposed electrode 21 and second opposed electrode 22.

In this embodiment, the first period and the second period are each shorter than the time required for particles 90 to pass through the region between first opposed electrode 21 and second opposed electrode 22. This can prevent particles 90 from flowing out of charger 2 without passing through either first charging region 211 or second charging region 222. Accordingly, this can prevent particles 90 from passing through the region between first opposed electrode 21 and second opposed electrode 22 without being charged.

Furthermore, in this embodiment, the embodiment of charger 2 in the first period and the second period is such that power supply 10 includes only a single power supply circuit 12 and two rectifying elements. In this embodiment, by simplifying the configuration of power supply unit 10 as described above, it is possible to realize size reduction and cost reduction of power supply unit 10.

[3. Summary]

As described above, charger 2 according to this embodiment includes: first opposed electrode 21 and second opposed electrode 22 disposed at mutually opposed positions; discharge electrode 23 between first opposed electrode 21 and second opposed electrode 22; and power supply unit 10 that applies an alternating-current voltage to at least one of first opposed electrode 21, second opposed electrode 22, and discharge electrode 23. A first period in which first charging region 211 is formed between first opposed electrode 21 and discharge electrode 23 and first non-charging region 221 is formed between second opposed electrode 22 and discharge electrode 23, and a second period in which second non-charging region 212 is formed between first opposed electrode 21 and discharge electrode 23 and second charging region 222 is formed between second opposed electrode 22 and discharge electrode 23 are repeated periodically by the application of the alternating-current voltage. In first charging region 211 and second charging region 222, particles 90 are charged to a same polarity, and the charging efficiency of particles 90 in first non-charging region 221 and second non-charging region 212 is lower than the charging efficiency of particles 90 in first charging region 211 and second charging region 222.

Accordingly, in charger 2, particles 90 can be charged in first charging region 211 in the first period and in second charging region 222 in the second period. Furthermore, in charger 2 according to this embodiment, particles 90 which pass through first charging region 211 and second charging region 222 are charged to the same polarity. In other words, particles 90 can be charged with unipolar ions (positive ions in this embodiment). Therefore, it is possible to prevent mixing of particles 90 charged with positive ions and particles 90 charged with negative ions and thereby prevent mutual charge neutralization between the positively charged particles and the negatively charged particles. As a result, deterioration of the charging efficiency can be reduced.

In addition, since an alternating-current voltage is applied to first opposed electrode 21, the orientation of the electric field formed between first opposed electrode 21 and second opposed electrode 22 is reversed between the first period and the second period. Therefore, charged particles 92 pass through between first opposed electrode 21 and second opposed electrode 22 while meandering. This can also prevent charged particles 92 from adhering to first opposed electrode 21 and second opposed electrode 22.

Furthermore, in charger 2 according to this embodiment, in the first period, the orientation of the component of the alignment direction of first opposed electrode 21 and second opposed electrode 22, in the spatial average electric field in first charging region 211, may coincide with the orientation of the component of the alignment direction, in the spatial average electric field in first non-charging region 221, and in the second period, the orientation of the component of the alignment direction, in the spatial average electric field in second charging region 222, may coincide with the orientation of the component of the alignment direction, in the spatial average electric field in second non-charging region 212.

As described above, in charger 2 according to this embodiment, in the space as a whole between first opposed electrode 21 and second opposed electrode 22, the orientation of the electric field reverses between the first period and the second period, and thus charged particles 92 pass through in the space while meandering, regardless of the location in the space. This can prevent charged particles 92 from adhering to first opposed electrode 21 and second opposed electrode 22.

Furthermore, in electric dust collector 1 according to this embodiment, the first period and the second period may be each shorter than the time required for particles 90 to pass through the region between first opposed electrode 21 and second opposed electrode 22.

This can prevent particles 90 from flowing out of charger 2 without passing through either first charging region 211 or second charging region 222. Therefore, this can prevent particles 90 from passing through the region between first opposed electrode 21 and second opposed electrode 22 without being charged.

Furthermore, in electric dust collector 1 according to this embodiment, power supply unit 10 further includes first rectifying element 141 connected between discharge electrode 23 and first opposed electrode 21, and second rectifying element 142 connected between discharge electrode 23 and second opposed electrode 22. Here, in a half cycle of an alternating-current voltage, discharge electrode 23 may have the same potential as the potential of either first opposed electrode 21 or second opposed electrode 22.

Because of this, it is possible to simplify the configuration of power supply unit 10 in this embodiment. Thus, it is possible to realize size reduction and cost reduction of power supply unit 10.

Furthermore, electric dust collector 1 according to this embodiment includes charger 2.

Accordingly, similar advantageous effects to charger 2 described above can be obtained by electric dust collector 1.

### Variations, Etc.

Although electric dust collector 1 according to the present disclosure is described above based on the foregoing embodiments, the present disclosure is not limited to the foregoing embodiments.

For example, the charger may be configured to reduce a residual charge of stray capacitance generated between discharge electrode 23, and first opposed electrode 21 and second opposed electrode 22. Delays in potential change in the respective electrodes may occur due to the influence of the residual charge of the stray capacitance. Due to the delays caused to potential change as described above, expected charging conditions cannot be obtained. Accordingly, for example, an abnormal corona discharge, a shorter charging time than expected, etc. may occur. Hereinafter, the charger configured to reduce the residual charge of the stray capacitance will be described with reference to a figure.

FIG. 7 is a circuit diagram outlining a circuit configuration of charger 2a according to a variation.

As illustrated in FIG. 7, charger 2a according to the variation includes first resistor element 161 connected in parallel to first rectifying element 141 and second resistor element 162 connected in parallel to second rectifying element 142, in addition to the configuration of charger 2 according to the foregoing embodiment. Including first resistor element 161 and second resistor element 162 as described above can reduce the residual charge of the stray capacitance generated between the electrodes. However, since each resistor element suffers ohmic loss, the resistance values of each resistor element is set to such an extent that the influence of the residual charge due to the stray capacitance can be reduced and ohmic loss can also be reduced. The resistance values of each resistor element can be made approximately 10 MΩ, for example.

Furthermore, in the foregoing embodiment, power supply unit 10 applies potentials to first opposed electrode 21, second opposed electrode 22, and discharge electrode 23 to periodically repeat the first period satisfying the relationships V3>V1 and V3=V2 and the second period satisfying the relationships V3>V2 and V3=V1, but the potentials to be applied by power supply unit 10 is not limited to such. Power supply unit 10 may apply potentials to periodically repeat the first period satisfying the relationships V3>V1 and V3≤V2 and the second period satisfying the relationships V3>V2 and V3≤V1. Furthermore, in charger 2, when particles 90 are to be charged negative, potentials may be applied to periodically repeat the first period satisfying the relationships V3<V1 and V3≥V2 and the second period satisfying the relationships V3<V2 and V3≥V1.

According to the configuration in which such potentials as described above is applied, similar advantageous effects as in the foregoing embodiment can be produced. Furthermore, with the configuration, in the first period, for example, the local electric field in the vicinity of discharge electrode 23 is mitigated, compared with the case where the same potential as first opposed electrode 21 is applied to second opposed electrode 22. Accordingly, an applied voltage required to initiate a corona discharge becomes high. Accordingly, the spatial electric field intensity in first charging region 211 can be improved, and thus quantity of saturated charge q of particles 90 which pass through the charger can be increased, as described using equation (1) above. In the second period too, quantity of saturated charge q can be increased, as in the first period.

Furthermore, when adopting the configuration in which such potentials as described above is applied, the configuration of power supply unit 10 may be changed. For example, discharge electrode 23 may be grounded, and two mutually synchronized power supply circuits for applying potentials to each of first opposed electrode 21 and second opposed electrode 22 may be included. Accordingly, the magnitude relationships among V1, V2, and V3 can be set arbitrarily.

Furthermore, the configuration of the dust collector only has to be able to separate charged particles 92 from the gas, and is not limited to electric dust collector 4 according to the foregoing embodiment. For example, in the dust collector, charged particles 92 may be separated from the gas by forming a traveling-wave electric field that travels in a direction crossing the direction of travel of the gas. Specifically, by disposing a plurality of electrodes having a plurality of linear electrodes as low-potential electrodes 42 described above and applying a changing voltage to each linear electrode of the electrodes, the traveling-wave electric field is formed between the electrodes. In addition, charged particles 92 may be separated from the gas by introducing the gas containing charged particles 92 between the electrodes. This can prevent charged particles 92 from adhering to the electrodes.

Furthermore, as the dust collector, a charged fibrous film may also be used. This can realize the dust collector having a simplified configuration.

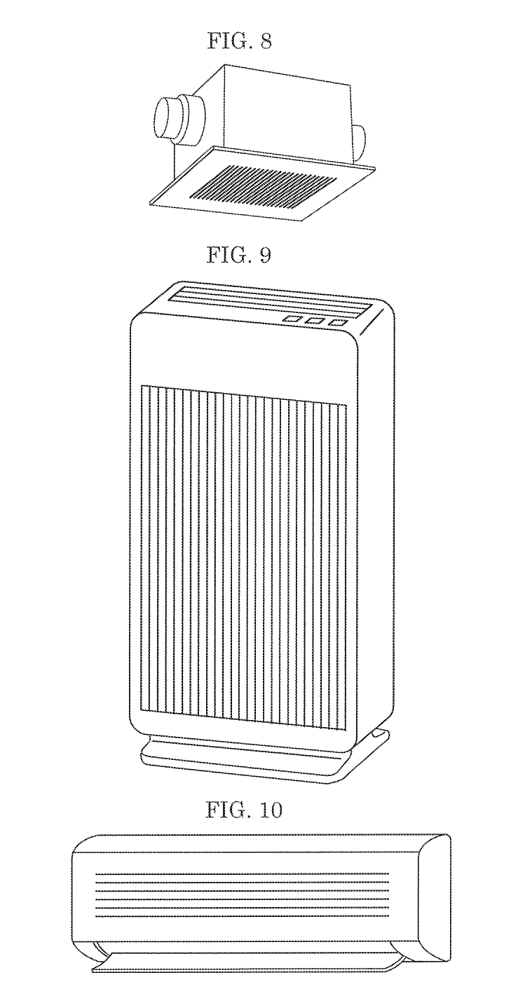

It should be noted that the charger and the electric dust collector including the charger according to the foregoing embodiment and variation thereof can be used for various apparatuses. For example, one aspect of the present disclosure can be realized as a ventilator illustrated in FIG. 8. FIG. 8 is a diagram illustrating an external appearance of a ventilator according to the variation. The ventilator illustrated in FIG. 8, for example, includes, internally, electric dust collector 1 according to the foregoing embodiment and is used in a ventilation system.

Furthermore, for example, one aspect of the present disclosure can be realized as an air cleaner illustrated in FIG. 9. FIG. 9 is a diagram illustrating an external appearance of the air cleaner according to the variation. The air conditioner illustrated in FIG. 9, for example, includes, internally, electric dust collector 1 according to the foregoing embodiment.

Furthermore, for example, one aspect of the present disclosure can be realized as an air conditioner illustrated in FIG. 10. FIG. 10 is a diagram illustrating an external appearance of the air conditioner according to the variation. The air conditioner illustrated in FIG. 10, for example, includes, internally, electric dust collector 1 according to the foregoing embodiment.

The present disclosure includes, for example, forms that can be obtained by various modifications to the respective embodiments and variations that may be conceived by those skilled in the art, and forms obtained by arbitrarily combining elements and functions in the respective embodiments without departing from the essence of the present disclosure.

### REFERENCE MARKS IN THE DRAWINGS

1 electric dust collector
2, 2a charger
10 power supply unit
21 first opposed electrode
22 second opposed electrode
23 discharge electrode
90 particle
92 charged particle
141 first rectifying element
142 second rectifying element
161 first resistor element
162 second resistor element
211 first charging region
212 second non-charging region
221 first non-charging region
222 second charging region

1. A charger that charges particles in gas, the charger, comprising:
a first opposed electrode and a second opposed electrode disposed at mutually opposed positions;
a discharge electrode between the first opposed electrode and the second opposed electrode; and
a power supply unit configured to apply an alternating-current voltage to at least one of the first opposed electrode, the second opposed electrode, and the discharge electrode, wherein
a first period in which a first charging region is formed between the first opposed electrode and the discharge electrode and a first non-charging region is formed between the second opposed electrode and the discharge electrode, and a second period in which a second non-charging region is formed between the first opposed electrode and the discharge electrode and a second charging region is formed between the second opposed electrode and the discharge electrode are repeated periodically by application of the alternating-current voltage, in the first charging region and the second charging region, the particles are charged to a same polarity, and charging efficiency of the particles in the first non-charging region and the second non-charging region is lower than charging efficiency of the particles in the first charging region and the second charging region.

2. The charger according to claim 1, wherein
in the first period, an orientation of a component of an alignment direction of the first opposed electrode and the second opposed electrode, in a spatial average electric field in the first charging electric region, coincides with an orientation of a component of the alignment direction, in a spatial average electric field in the first non-charging region, and
in the second period, an orientation of a component of the alignment direction, in a spatial average electric field in the second charging region, coincides with an orientation of a component of the alignment direction, in a spatial average electric field in the second non-charging region.

3. The charger according to claim 1, wherein
the first period and the second period are each shorter than a time required for the particles to pass through a region between the first opposed electrode and the second opposed electrode.

4. The charger according to claim 1, wherein
the power supply unit includes:
a first rectifying element connected between the discharge electrode and the first opposed electrode; and
a second rectifying element connected between the discharge electrode and the second opposed electrode, and
in a half cycle of the alternating-current voltage, the discharge electrode has a same potential as a potential of either the first opposed electrode or the second opposed electrode.

5. The charger according to claim 4, further comprising:
a first resistor element connected in parallel to the first rectifying element; and
a second resistor element connected in parallel to the second rectifying element.

6. A charger, comprising:
a first opposed electrode and a second opposed electrode disposed at mutually opposed positions;
a discharge electrode between the first opposed electrode and the second opposed electrode; and
a power supply unit configured to apply voltages to the first opposed electrode, the second opposed electrode, and the discharge electrode, wherein
when a potential applied to the first opposed electrode is denoted by V1, a potential applied to the second opposed electrode is denoted by V2, and a potential applied to the discharge electrode is denoted by V3, the power supply unit is configured to apply voltages to the discharge electrode, the first opposed electrode, and the second opposed electrode to periodically repeat a first period satisfying relationships V3>V1 and V3≤V2 and a second period satisfying relationships V3>V2 and V3≤V1, or to periodically repeat a first period satisfying relationships V3<V1 and V3≥V2 and a second period satisfying relationships V3<V2 and V3≥V1.

7. An electric dust collector, comprising:
the charger according to claim 1.

8. A ventilator, comprising:
the electric dust collector according to claim 7.

9. An air cleaner, comprising:
the electric dust collector according to claim 7.
